(19) United States
(12) Patent Application Publication
(10) Pub. No.: US 2012/0102414 A1
(43) Pub. Date: Apr. 26, 2012

(54) DISTRIBUTED CONTROLLER OF A USER INTERFACE FRAMEWORK FOR WEB APPLICATIONS

(76) Inventors: Hilmar Demant, Karlsdorf (DE); Sebastian Droll, Heidelberg (DE); Joachim Fitzer, Schriesheim (DE); Ioannis Grammatikakis, Maxdorf (DE); Jan Heiler, Walldorf (DE); Juergen Sattler, Wiesloch (DE); Frank Schertel, Mannheim (DE); Markus Viol, Walldorf (DE); Thorsten Weber, Mannheim (DE)

(21) Appl. No.: 12/908,893

(22) Filed: Oct. 21, 2010

(51) Int. Cl. G06F 3/048; G06F 15/16

(52) U.S. Cl. 715/753

(57) ABSTRACT

Various embodiments of systems and methods for improved user interface framework for Web applications are described herein. The UI framework is based on the MVC architectural pattern. An additional controller, a server controller, is included in the server part of the user interface framework runtime. A client controller is running at the client side of the user interface framework runtime. The client controller and the server controller form one logical synchronized controller. The server controller ensures that all needed controller calculations, which would lead to additional roundtrips between the client side and the server side, can be done on the server side. Thus, exact one roundtrip between client side and backend for every user interaction and transporting only the bare minimum of data needed to render the current UI state is achieved.

### FIELD

The field generally relates to the software arts, and, more specifically, to methods and systems for a distributed controller of a user interface framework for Web applications.

### BACKGROUND

In the world of computing, Web applications such as Rich Internet Applications (RIAs) have many of the characteristics of desktop applications. The RIAs are typically delivered either by a site-specific browser, a browser plug-in, or independently via a virtual machine. The most commonly used frameworks that support such Web applications are Adobe Flash, Java, and Microsoft Silverlight. Generally, the framework has to be installed using the computer's operating system prior to launching the RIA. The Web application framework typically downloads, updates, verifies, and executes the RIA. Microsoft Silverlight (WPF/E) is a programmable Web browser plug-in that enables features such as animation, vector graphics and audio-video playback that characterize RIAs. Microsoft Silverlight brings additional interactivity features and support for .NET languages and development tools. It is compatible with multiple Web browser products. Silverlight, which was developed under the codename Windows Presentation Foundation/Everywhere (WPF/E), is a web-based subset of WPF.

Many Web application frameworks follow the Model View Controller (MVC) architectural pattern to separate the data model with the business logic from the user interface. The MVC pattern modularizes code, promotes code reuse (use of existing software code, or software knowledge, to build new software code), and allows multiple interfaces to be applied. The MVC architecture consists of a model, a view, and a controller. The model part of the MVC pattern is a domain-specific representation of the data upon which the application operates. Domain logic adds meaning to raw data (for example, calculating the totals, taxes, and shipping charges for shopping cart items). When a model changes its state, it notifies its associated views so they can refresh. The view of the MVC pattern renders the model into a form suitable for interaction, typically a user interface element. Multiple views can exist for a single model for different purposes. The controller of the MVC pattern receives input and initiates a response by making calls on model objects. When a Web application user interface framework is built on the MVC architectural pattern approach, high speed development of uniform user interfaces (UIs) is possible.

### SUMMARY

Various embodiments of systems and methods for a distributed controller of a user interface framework for Web applications are described herein. In an embodiment, the method includes receiving a user input from a user interface element at a client controller, where the client controller is included in a user interface framework at a frontend device. The method further includes updating a user interface model data in response to the received user input and sending the updated user interface model data from the client controller to a server controller at a backend device. Further, business data is updated in response to the updated user interface model data, where the business data is included in a business data model bound to the user interface model. Finally, only the updated business data is sent back to the client controller.

In an embodiment, the system includes a database storage unit for storing user interface entities with their metadata. The system also includes a frontend unit including a client controller, wherein the client controller receives a user input from a user interface element and updates data in a user interface model. A backend unit including a server controller is included in the system, wherein the server controller receives the updated user interface model data from the client controller, updates business data in response to the updated user interface model data, and sends only the updated business data back to the client controller.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an architectural view of a user interface framework as part of an application platform.

FIG. 2A is a block diagram illustrating a generic logical component model.

FIG. 2B is a block diagram illustrating a logical component structure.

FIG. 3 is a block diagram illustrating an additional controller in the MVC architecture for defining UIs, according to an embodiment.

FIG. 4 is a flow diagram illustrating the communication between the client controller and the server controller in the UI framework, according to an embodiment.

FIG. 5 is a block diagram illustrating an exemplary computer system 500.

### DETAILED DESCRIPTION

Embodiments of techniques for a distributed controller of a user interface framework for Web applications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

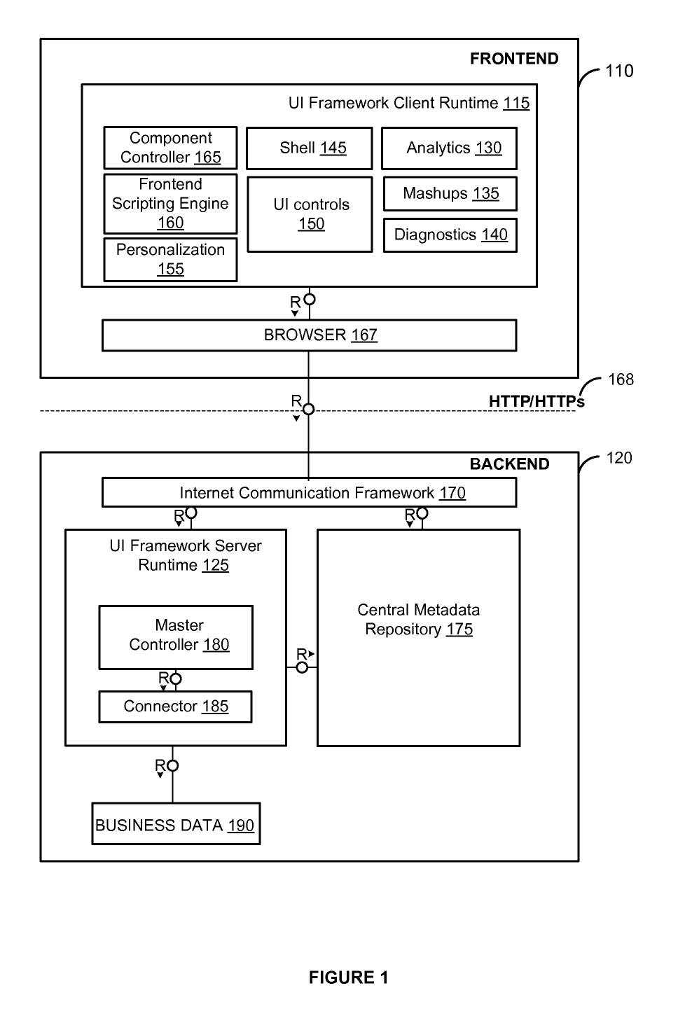

FIG. 1 is a block diagram illustrating an architectural view of a user interface framework as part of an application platform. The application platform is a Web application server including a frontend (client) part 110 and a backend (server) part 120. The UI framework as part of the application platform is responsible for generating, rendering, and managing user interfaces. The UI framework enables the full separation of UI entities in multiple clients, provides a rendering-engine-independent definition of application UIs and has all the personalization and flexibility features built-in. The UI framework is based on the RIA concept, which removes the need of running Java server in the middle tier for application UI purposes. In this way, the complexity of the UIs is reduced significantly. The UI framework includes a client part—UI Framework Client Runtime 115, and a server part—UI Framework Server Runtime 125.

UI Framework Client Runtime 115 may be implemented in a programming language such as “C#” using a RIA based framework such as Microsoft Silverlight technology. The UI Framework Client Runtime 115 is responsible for rendering user interfaces and access business data from backend 120. Every user request is triggered on the UI Framework Client Runtime 115. The very first request is a navigation request that results in a request to the backend 120 to read a UI component. The UI component is read from the Central Metadata Repository 175 in the backend 120 and transported to the frontend 110. A component manager instantiates the UI component and a corresponding component controller 165 for the UI component on the frontend 110 and triggers the initialization of the UI component on the backend 120. The component manager builds up a control tree for the UI component out of a set of UI controls 150. These UI controls 150 ensure conformable look and feel and the ability to change UI themes consistently. The controls in the “themed UI controls” package are all enabled in a consistent way for test automation and accessibility, and are provided in a manner that all native implemented custom UI panes can take use of that controls. Usually, more than one UI component is needed to render a UI, as UI components typically embed other UI components (e.g., a Work Center component embeds a set of Work Center View Components and they again embed other components). The top-level UI component that is rendered is the root UI component which makes sure to render a common frame for all UI components, e.g., by rendering the top level navigation and the ability for personalization from personalization 155 unit.

In an embodiment, the UI Framework Client Runtime 115 also comprises the following built-in units: analytics 130, mashups 135, diagnostics 140, shell 145, and frontend scripting 160. Analytics 130 are components that represent data in a grouped, aggregated, and hierarchical way. These components serve to answer business questions about, for example, how many products were sold in a particular country and provide drill down capabilities to different level of abstraction. Diagnostics 140 allows the collection of, for example, the context of the current framework and all other running entities of the overall system at a specific point in time (e.g., in case of an exception or error). The collected information can help to track down the cause of the exception. Shell unit 145 provides the shell for running the UI Framework Client Runtime. It includes all units for the user interface ranging from defining the overall appearance of windows (including standard elements like menus, toolbars, navigation areas, windows management) as well as the mediator layer that maps logical component definitions from the configuration model to physical controls. Shell unit 145 represents a standalone native client (WPF) based on the Silverlight technology. Frontend scripting 160 enables data from the client side data model to be read, evaluated, and modified—which causes eventually configured events again in the runtime execution of the model. With these capabilities, UI-only logic can be expressed and modeled via some script; it is not required to implement or model the logic in the backend. Optionally, the script can be executed on the client or backend.

The frontend 110 communicates with the backend 120 via browser 167 on a regular HTTP/HTTPs connection 168 using JavaScript Object Notation (JSON) (also other serialization formats such as XML can be used in parallel to JSON) as a lightweight data interchange format. The requests from the frontend 110 are received at Internet Communication Framework (ICF) 170. The ICF 170 forwards the requests to the UI Framework Server Runtime 125 and Central Metadata Repository 175. The Central Metadata Repository 175 stores all UI entities with their metadata. The UI Framework Server Runtime 125 reads and interprets the UI model of the application, manages the access to the backend and ensures an optimized communication with the UI Framework Client Runtime 115. After the UI Framework Client Runtime 115 triggers the initialization of a UI component in the backend 120 for a first time in a session, the UI Framework Server Runtime 125 first creates a master controller 180 for the complete session and then creates a component controller for each component that is requested from the UI Framework Client Runtime 115. Each component controller builds a UI data container out of the information of the UI model for a component. At runtime, the composition of the dependent components is combined within the master controller 180, which holds one event queue and performs data updates for all included components as one component. In an embodiment, it can be configured that logically separated declared components to run as one virtual controller at runtime.

After the master controller 180 has processed all component controllers, it collects all the data that has changed in the UI data container and makes sure that all changed data and only the changed data is transported to the client 110. The access from the UI Framework Server Runtime 125 to business data 190 is performed via connector 185. Connector 185 is able to connect to different technologies.

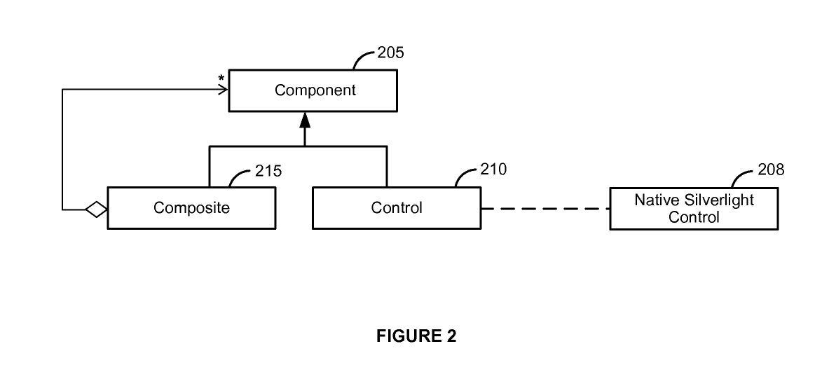

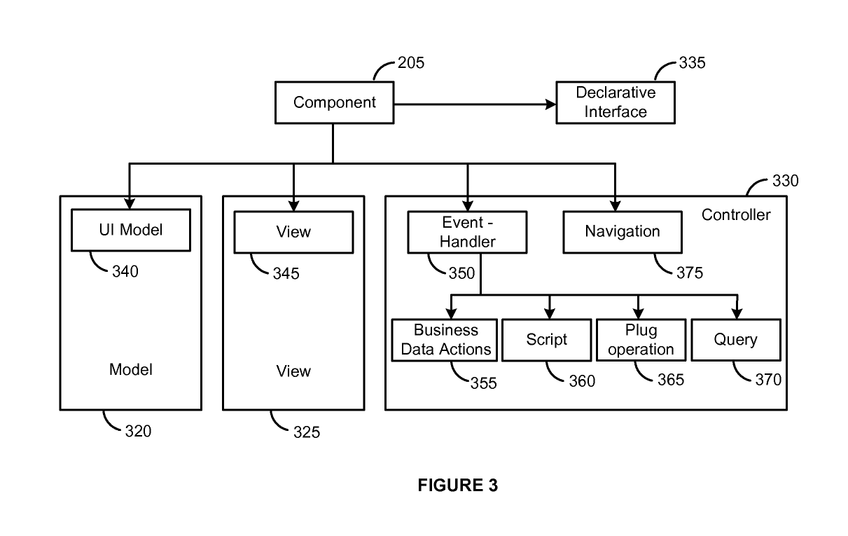

FIG. 2 is a block diagram illustrating a generic logical component model. In the UI framework, a component 205 is a self-contained model of a user interface that can be declaratively used in another UI model. A component can be a control, such as control 210—provided by the UI framework or implemented with some software development kit (SDK) or application programming interface (API) for framework controls. A native Silverlight control 208 can also be included in case the UI framework does not provide support for a particular control. In this case, there is an extension mechanism through implementing a framework interface (or deriving from an abstract framework class) to allow plugging in any arbitrary implementation of a native Silverlight control into the declared components. In the model, some constructs exist that allow plugging in such custom panes. A control cannot contain other components. A component can also be a composite (Composite Control, Building Block), such as composite 215, which is composed out of a set of components (nested composites and/or controls). A composite allows a group of objects to be treated in the same way as a single instance of an object. A composite implements all component methods. The component is the abstraction for all components, including composite ones, and declares an interface for the objects in the composition.

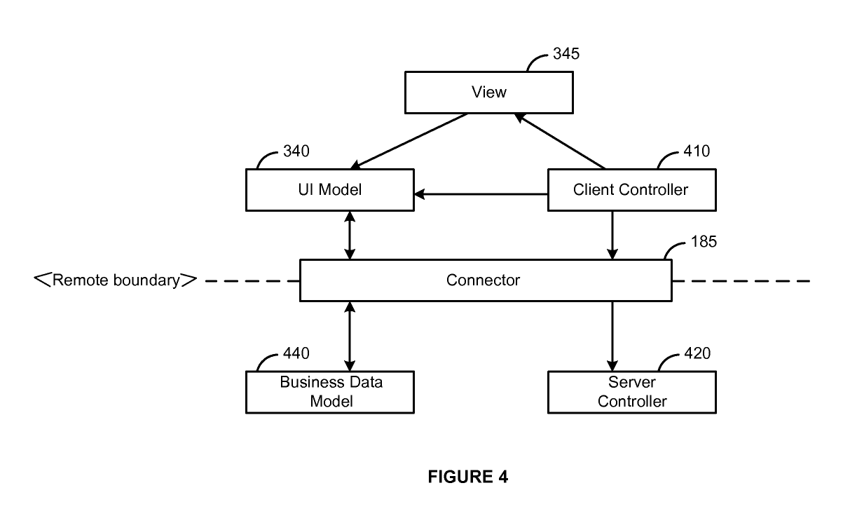

FIG. 3 is a block diagram illustrating a logical component structure. Component 205 consists mainly of a model 320, a View 325, a Controller 330, and a declarative interface 335. View 325 consists of a set of views, such as view 345, which is the description of the user interface that binds to the UI model 340 and triggers event-handlers such as event-handler 350. The UI model 340 describes a data structure, which can bind to backend business data 190. Controller 330 includes different types of event-handlers such as: business data actions 355, script 360, plug operations 365, and query 370. Business data actions 355 include several types of actions defined in the metadata and exposed through the implementation of the business objects. From the UI, an operation of type “BOAction” could be used to trigger a particular action in the context of the current data instance, which again potentially can change the state and data as well. Script 360 is a declaring script logic on the data instances (read, evaluate, modify) with branches, conditions, etc. A plug operation, from plug operations 365, triggers one of the defined out-ports which are used to couple components (embedded or navigation) together. Query 370 in combination with a filter set called “DefaultSets” can be executed from an event handler operation. The defined query of the business object is executed and the query result data is filled into the configured data model list. Navigation 375 is the context mapping for outgoing-incoming operations. The declarative interface 335 exposes ports (in-port and out-port), binding-capabilities for tightly coupled behavior in embedded scenarios, and configuration to the composition environment.

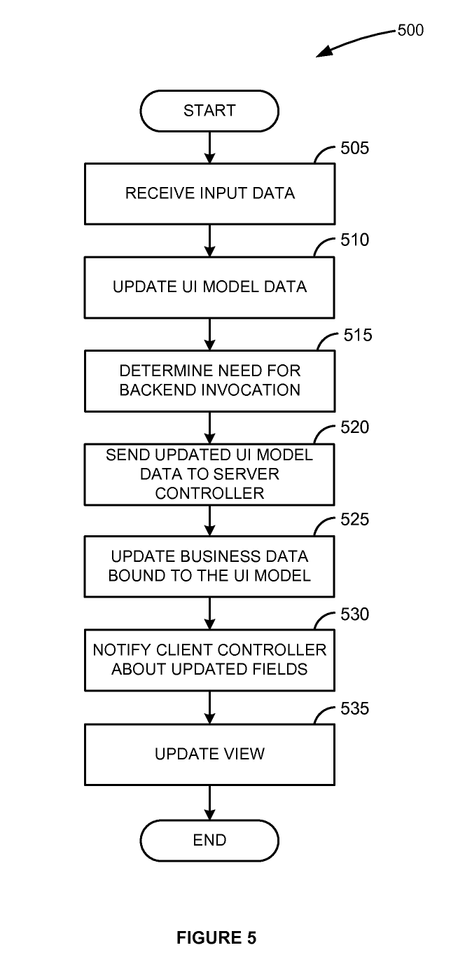

FIG. 4 is a block diagram illustrating an additional controller in the MVC architecture for defining UIs, according to an embodiment. There are some challenges in the case of a distributed system, when the business logic is running on the backend and the user interface is running on the frontend and there is a need for a very tight coupling with the business logic on the backend (e.g., real-time reaction depending on changes on the server, real-time input checks and validations, business checks depending on large amount of data that cannot be done on the client, but influence immediately the user interface). In that kind of distributed setups, the bandwidth and latency of the connection is the most critical parameter and several enhancements to the MVC paradigm have to be applied to optimize this resource.

In an embodiment, the number of roundtrips between the frontend and the backend is minimized and the amount of data exchanged is reduced to a minimum. The goal is to achieve exact one roundtrip between the frontend 110 and backend 120 for every user interaction and transport only the bare minimum of data needed to render the current UI state. This leads to some challenges in the implementation of the MVC pattern such as: 1) some parts of the controller logic have to be executed in the UI Framework Server Runtime 125 and some parts in the UI Framework Client Runtime 115; 2) there are several use cases where the UI state is needed at the backend 120 (e.g., select a line, select a tab, etc.); 3) there are several use cases, where transporting the UI state always to the backend can be a drawback (e.g., tabbing through a table and moving the input focus from field to field); and so on.

In an embodiment, an additional server controller 420 is introduced in the MVC model that runs on the UI Framework Server Runtime 125. Since, the MVC approach to define the UIs is used, big parts of the controller logic can be provided as a generic distributed controller which has some parts in the backend, such as server controller 420, and some parts in the frontend such as client controller 410. This generic controller can involve some application specific code either in the frontend or in the backend in some predefined points. The server controller 420 ensures that all needed controller calculations, which would lead to additional roundtrips, can be done on the backend. In addition, for the controller to operate properly, the data model must also exist in the backend as business data model 440 and be synchronized with the UI model 340 in the frontend with every roundtrip. The metadata of the business data model 440 can expose metadata about the state of data model elements. The UI framework consumes this metadata and steers, e.g., visibility of the user interface elements based on this metadata.

For every UI component, the generic component controller for this component is instantiated. If a custom UI pane is to be rendered then the corresponding custom component controller is instantiated. The component controller makes sure that all controls are bound to the proper fields of the UI model and executes all operations that are configured in the event handlers of the UI component. In case that in the event handlers some script segments are found, the controller triggers the execution of these scripts in the frontend scripting engine 160. The component controller can also trigger a roundtrip to the backend. In that case the backend synchronization manager identifies all changed data in the UI model in the client 110 and packs only the changed data in a request to the backend 120. After the server controller 420 computes the data in the backend 120, all changed data and only the changed data from the backend 120 (including all data changed via side effects) is transported back to the frontend 110.

In an embodiment, the UI rendering starts in parallel to the generic controller initialization and the roundtrips for data retrieval. The client controller 410 and the server controller 420 of the generic controller are initialized asynchronously. Once, both sides of the generic controller have completed the initialization, the generic controller is shifted in “running” state. Further, the initialization of the generic controller is performed asynchronously from the rest of the UI Framework Client Runtime 115. Model parsing and view rendering can already be performed while the generic controller is in “starting” state. Although, the generic controller is physically distributed on the frontend and backend, it remains as one logical unit synchronized between its parts.

The server controller 420 is independent of the underlying business logic layer. The smallest independently executable entity within the UI Framework Server Runtime 125 is a “command”. To enable the consumption of different business logic layers, an extensible “command” framework has been provisioned. Data synchronization and the execution of controller operations (which are used to compose event handlers) are prepared via a command compiler. During this phase, each operation is decomposed into its “commands”, which are bundled per controller execution phase. Consecutive operations which are processed by the server controller 420 are chained and the commands are executed together.

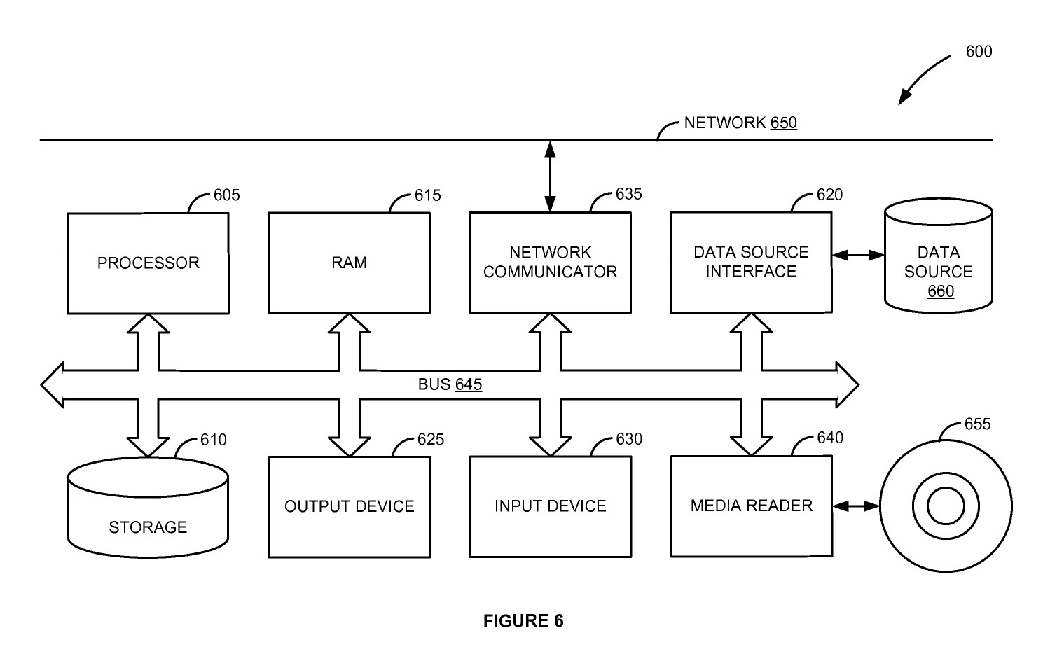

FIG. 5 is a flow diagram illustrating the communication between the client controller and the server controller in the UI framework, according to an embodiment. At block 505, user input data is received from a user interface element. The user input may be in the form of: entering data in a field, selecting an indicator, selecting an item of a drop-down menu, and so on. The user input is received at the client controller 410. The client controller 410 initiates a response by making calls on UI model 340 objects. The UI model 340 describes data structures that are bound to backend data, such as business data 190. The client controller 310 accepts input from the user and instructs the UI model 340 and view 345 to perform actions based on that input. At block 510, the UI model 340 is updated in response to the performed actions based on the received user input data. The UI model 340 is used to manage information and notify event handlers when that information changes.

At block 515, the client controller 410 determines if the backend business logic 190 has to be invoked in response to the user input. In some embodiments, the business logic has to be invoked to process the actions corresponding to the user input, e.g., in processing a payment of a purchase, the user has to decide the payment method and upon a selection of a payment method, a new screen or additional UI elements have to be displayed. In this case, the UI client framework has to invoke the UI server framework on the backend to render new UI elements. In other embodiments, the invocation of the backend business logic may not be necessary, e.g., when the user moves from one UI element to another (using “tab”), the client controller 410 sets focus to the current UI element without invoking the backend.

At block 520, the updated UI model 340 data is sent to server controller 420 at the backend. The server controller 420 updates the business data bound to business data model 440 with the updated data from the UI model 340, at block 525. Refresh of the business data may be triggered by the server controller 420. The server controller 420 sends the updated data back to the client controller 410 only in response. At block 530, the client controller 410 is notified about the updated data. The runtime UI data model is synchronized via the response of the backend. Based on that, all registered view elements to this data model are updated with the current values. At block 535, the corresponding view elements (or views) are updated by rendering the UI model with the updated data.

In an embodiment, in the controller section 330 of a UI component, several operations can be used that are supported from the UI framework. Theses operations can be used in “event handlers”, which can be configured for different events (e.g., when an in-port is triggered, when a button is clicked, and so on). A generic model for event handlers allows a sequence of arbitrary operations to be executed based on an event source. Metadata allows synchronous and asynchronous execution of operations to be steered. Event handlers can be declared containing a sequence of modeled operations. These event handlers can be registered at specific points in the UI model 320 such as: for view elements—a button on click; for data model events—on value change for fields; etc.

The operation types include a “BOOperation”—can be all kind of implicit actions on a business object (BO) or other business logic entity. The following operation types are supported: read, create, edit, and delete a BO based on a node identifier or a key specified in the operation parameters. A “BOAction” operation type—triggers a configured BO action of the BO model. “Script”—a script as an operation type represents extended UI logic that can react on and manipulate the context of the running component. “FirePlug” triggers communication either to an internal embedded component or to an external component directly (via navigation) or a communication message to another listening component (via notification or broadcast). “ExecuteDefaultSet”—triggers a default set (a packaged filter directly assigned to a particular query) and will return the data result in a data list of the data model context. “ValueHelpOperation” trigger a value help operation with the given context (instance based) on the defined BO and query or default set. “DataOperation” is a primitive operation to manipulate directly the data model, e.g., to write a value from some location into a data field.

“ListOperation” lists data models and serves for editing a given data model list. “WindowAction” enables save and commit operations to be invoked and a session to be closed. “Condition” is a primitive operation such as a declarative switch case, which can evaluate an expression (e.g., from a data field) and define different branches for a particular branch. For each branch, a sequence of operations can be defined. “MessageBox” is a framework feature to model a message box to the user in different variants and specify the invocation of an event handler on “ok” or “cancel” UI button or any other custom button on the message box. “ShowModalDialog” triggers the in-component modal dialog to open (waiting for user input). There are two types of modeled modal dialogs in the UI framework. One is “in-component modal dialog”, which means that a separate declaration of the dialog exists in a parent component model. The in-component modal dialog is not a component on its own as it is part of another component definition. In contrast to that, there is a real modal dialog component (for reuse reasons) which is described in it s own component definition. “FireEventHandler” enables the reuse of declared sequences of operations. “ExecuteContainerExitAction” invokes a custom defined action in the backend; used together with exit classes on a data model, where the data retrieval is handled in a custom implementation at the backend.

“CustomControllerExtensionAction” a client (frontend) side operation extension that invokes a specific assembly with a custom code and access to the actual UI runtime context. “DocumentOutputOperation” invokes an export to a document (e.g., Microsoft Office Word document) with configured data and template. “CreateSupportRequest” triggers the context collection for a support issue including navigation to a UI to maintain the data for the support issue. “PDFOutputOperation” invokes an export of the data to a PDF document, which will be displayed on a UI screen.

UI frameworks especially in the “on demand” delivery model have to reasonable tradeoff between throughput and latency to achieve a superior end user experience. The optimized strategy may heavily depend on variables like network latency and server load, which might change dynamically and depend on the location. The UI framework is capable to support many small roundtrips as well as few highly aggregated roundtrips without influencing the functional behavior. Hence, the tradeoff between latency and throughput can be dynamically adjusted according to the current variables (e.g., network load) and previous component dependencies at runtime.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

FIG. 6 is a block diagram illustrating an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be access via one or more abstraction layers implemented in hardware or software. For example, the data source 660 may be access by network 650. In some embodiments the data source 660 may be accessed via an abstraction layer, such as, a semantic layer.

A data source 660 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive a user input from a user interface element at a client controller, the client controller included in a user interface framework at frontend;
update data in a user interface model in response to the received user input;
send the updated user interface model data from the client controller to a server controller at backend;
update business data in response to the updated user interface model data, the business data included in a business data model bound to the user interface model; and
send only the updated business data back to the client controller.

2. The article of manufacture of claim 1, wherein the instructions further cause the computer to:
notify the client controller about the updated business data; and
render the user interface model via a view element with the updated business data.

3. The article of manufacture of claim 1, wherein the instructions further cause the computer to initialize the client controller and the server controller asynchronously.

4. The article of manufacture of claim 2, wherein the notify the client controller instruction causes the computer to raise an event to the client controller.

5. The article of manufacture of claim 1, wherein the client controller and the server controller are one logical controller physically distributed on the frontend and the backend.

6. The article of manufacture of claim 4, wherein the client controller is synchronized with the sever controller.

7. The article of manufacture of claim 6, wherein the instructions further cause the computer to:
register an event handler in the user interface model, the event handler including a sequence of operations; and
execute an operation from the sequence of operations based on the event.

8. A computerized method comprising:
receiving a user input from a user interface element at a client controller, the client controller included in a user interface framework at a frontend unit;
updating data in a user interface model in response to the received user input;
sending the updated user interface model data from the client controller to a server controller at a backend unit;
updating business data in response to the updated user interface model data, the business data included in a business data model bound to the user interface model; and
sending only the updated business data back to the client controller.

9. The method of claim 8, further comprising:
notifying the client controller about the updated business data; and
rendering the user interface model via a view element with the updated business data.

10. The method of claim 8, further comprising:
initializing the client controller and the server controller asynchronously.

11. The method of claim 9, wherein notifying the client controller comprises:
raising an event to the client controller.

12. The method of claim 8, wherein the client controller and the server controller are one logical controller physically distributed on the frontend unit and the backend unit.

13. The method of claim 9, wherein the client controller is synchronized with the sever controller.

14. The method of claim 9, further comprising:
registering an event handler in the user interface model, the event handler including a sequence of operations; and
executing an operation from the sequence of operations based on the event.

15. A computing system comprising:
a database storage unit for storing user interface entities with their metadata;
a frontend unit including a client controller, wherein the client controller receives a user input from a user interface element and updates data in a user interface model;
a backend unit including a server controller, wherein the server controller receives the updated user interface model data from the client controller, updates business data in response to the updated user interface model data, and sends only the updated business data back to the client controller.

16. The computing system of claim 15, wherein the database storage unit comprises a business data model representing the business data and bound to the user interface model.

17. The computing system of claim 15, further comprising an event handler registered in the user interface model including a sequence of operations.

18. The computing system of claim 15, wherein the client controller and the server controller are one logical controller physically distributed on the frontend unit and the backend unit.

19. The computing system of claim 15, wherein the client controller and the server controller are initialized asynchronously.

20. The computing system of claim 15, wherein the client controller is synchronized with the sever controller.
